(19) United States
(12) Patent Application Publication
(10) Pub. No.: US 2014/0136596 A1
(43) Pub. Date: May 15, 2014

(54) METHOD AND SYSTEM FOR CAPTURING AUDIO OF A VIDEO TO DISPLAY SUPPLEMENTAL CONTENT ASSOCIATED WITH THE VIDEO

(71) Applicant: YAHOO! INC., Sunnyvale, CA (US)

(72) Inventors: Allie K. Watfa, Urbana, IL (US); Jonathan Kilroy, Champaign, IL (US); Dale Nussel, Mahomet, IL (US)

(73) Assignee: YAHOO! INC., Sunnyvale, CA (US)

(21) Appl. No.: 13/673,720

(22) Filed: Nov. 9, 2012

(51) Int. Cl. G06F 15/16

(52) U.S. Cl. 709/203

(57) ABSTRACT

A system and method for providing a user with supplemental content associated with a product or item the user sees or hears in a video. The system and method include receiving, by a server computer over a network from a client device, an audio clip associated with a portion of a video; determining, by the server computer, that the video is a specific media program; using, by the server computer, the captured audio clip to map the portion of the video with supplemental content for a product associated with the portion of the video; and communicating, by the server computer, the supplemental content for the product to the client device for display on the client device.

### FIELD

The present disclosure relates to supplemental content associated with a media program, and more specifically to displaying supplemental content associated with a product displayed in a media program.

### BACKGROUND

Internet-based video streaming has grown and continues to grow in popularity. For example, web sites such as YouTube® and Hulu® enable users to select video clips, such as television programs, movies, or personal videos, for display on a browser. In some cases, commercials are inserted between scenes of a video. Currently, however, advertisements associated with a video are typically not related to or are only tangentially related to the video. For example, an automobile advertisement may be inserted between scenes of a video that is not related to automobiles. This tends to diminish the effectiveness of the advertisement, which results in a lower associated conversion rate for the advertisement.

### SUMMARY

Additionally, many videos display or include products in the videos. Specifically, a television show or movie may show or discuss a particular product, such as a particular food, drink, an automobile brand, an automobile model, etc. For example, the movie “E.T.: The Extra-Terrestrial®” had scenes featuring the “Reese's Pieces®” candy. Currently, if a user sees a product featured in a movie or television show, and if the user cannot identify the name or brand of the product, the user has no easy way to find out more information about the product or purchase the product.

The present disclosure relates to providing a user with supplemental content associated with a product or item the user sees or hears in a video. In one aspect, a method and system include receiving, by a server computer over a network from a client device, an audio clip associated with a portion of a video; determining, by the server computer, that the video is a specific media program; using, by the server computer, the captured audio clip to map the portion of the video with supplemental content for a product associated with the portion of the video; and communicating, by the server computer, the supplemental content for the product to the client device for display on the client device.

In one embodiment, the server computer determines that the product is referenced in the portion of the video, such as determining that the audio clip references the product and/or determining that a frame in the portion of the video includes the product. In one embodiment, the server computer receives a listing of supplemental content for the specific media program. In one embodiment, the receiving of the listing of supplemental content further comprises receiving supplemental content for specific time segments of the specific media program.

Examples of a video include a television program, a movie, a commercial, and/or internet content. Examples of supplemental content for the product include product information, a coupon, an advertisement, a web page, a link to a web page, and a commercial.

In one embodiment, the server computer tailors the supplemental content for a user based on user information. The tailored supplemental content can be tailored based on user information such as user interests, demographics, location, home address, weather at the location, weather at the home address, social network connections of the user, social network friends of the user, age, income, education, recent purchases, web sites visited recently, gender, marital status, and occupation.

In one aspect, a method and system include transmitting, by a server computer over a network to a client device, a mobile application, the mobile application including supplemental content associated with a plurality of media programs. The mobile application is configured to capture, by the client device, an audio clip associated with a portion of a video; determine, by the client device from the audio clip, that the video is a specific media program in the plurality of media programs; determine, by the client device, supplemental content for a product associated with the portion of the video; and display, by the client device, the supplemental content.

In one aspect, a method and system include receiving, by a server computer over a network from a client device, an audio clip associated with a portion of a video; determining, by the server computer, that the video is a specific media program; extracting, by the server computer, audio from the captured audio clip; mapping, by the server computer, the extracted audio to a keyword; mapping, by the server computer, the keyword to a product; determining, by the server computer, supplemental content for the product; and communicating, by the server computer, the supplemental content for the product to the client device for display on the client device. In one embodiment, the server computer receives mappings from keywords to products. In one embodiment, the server computer receives a listing of supplemental content for the specific media program.

These and other aspects and embodiments will be apparent to those of ordinary skill in the art by reference to the following detailed description and the accompanying drawings.

### BRIEF DESCRIPTION OF THE DRAWINGS

In the drawing figures, which are not to scale, and where like reference numerals indicate like elements throughout the several views:

FIG. 1 is a block diagram of a client device communicating over a network with a server computer in accordance with an embodiment of the present disclosure;

FIG. 2 is a flowchart illustrating steps performed by the server computer and the client device to provide and obtain supplemental content in accordance with an embodiment of the present disclosure;

FIG. 3 is a flowchart illustrating steps performed by the server computer and the client device to provide and obtain supplemental content in accordance with an embodiment of the present disclosure;

FIG. 4 is a block drawing of a database illustrating a mapping of audio to keywords to products in accordance with an embodiment of the present disclosure;

FIG. 5 is a block diagram of a client device in communication with a television in accordance with an embodiment of the present disclosure;

FIG. 6 is a block diagram of components of a client device in accordance with an embodiment of the present disclosure; and

FIG. 7 is a block diagram illustrating an internal architecture of a computer in accordance with an embodiment of the present disclosure.

### DESCRIPTION OF EMBODIMENTS

Embodiments are now discussed in more detail referring to the drawings that accompany the present application. In the accompanying drawings, like and/or corresponding elements are referred to by like reference numbers.

Various embodiments are disclosed herein; however, it is to be understood that the disclosed embodiments are merely illustrative of the disclosure that can be embodied in various forms. In addition, each of the examples given in connection with the various embodiments is intended to be illustrative, and not restrictive. Further, the figures are not necessarily to scale, some features may be exaggerated to show details of particular components (and any size, material and similar details shown in the figures are intended to be illustrative and not restrictive). Therefore, specific structural and functional details disclosed herein are not to be interpreted as limiting, but merely as a representative basis for teaching one skilled in the art to variously employ the disclosed embodiments.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

The present disclosure is described below with reference to block diagrams and operational illustrations of methods and devices to select and present media related to a specific topic. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved. Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

Throughout the specification and claims, terms may have nuanced meanings suggested or implied in context beyond an explicitly stated meaning Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

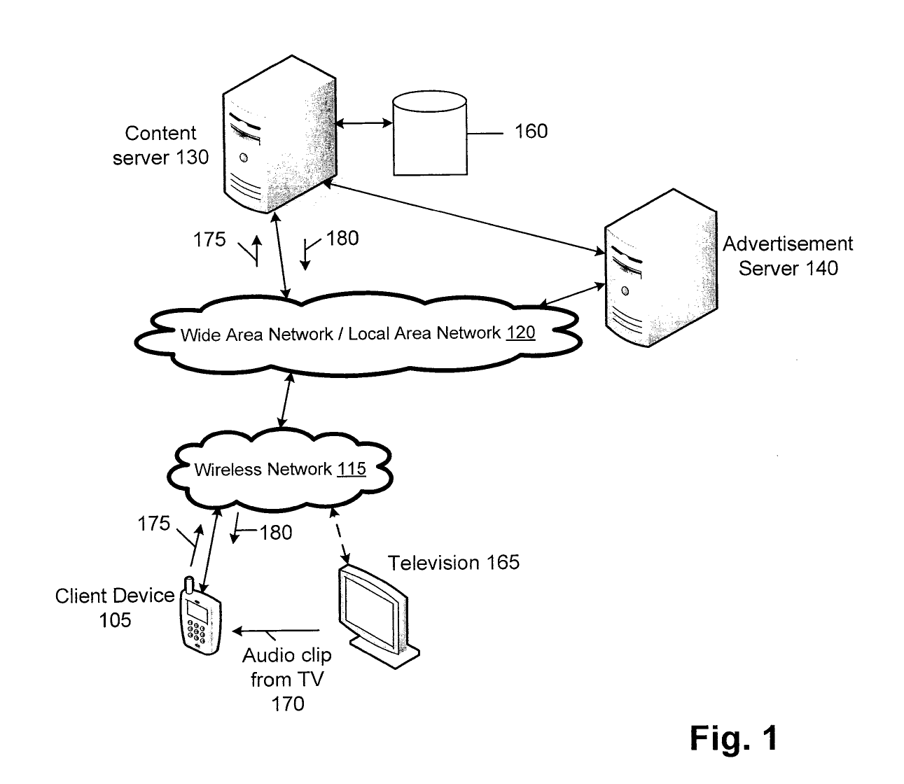

FIG. 1 is a schematic diagram illustrating an example embodiment of a network and devices implementing embodiments of the present disclosure. Other embodiments that may vary, for example, in terms of arrangement or in terms of type of components, are also intended to be included within claimed subject matter. FIG. 1 includes, for example, a client device 105 in communication with a content server 130 over a wireless network 115 connected to a local area network (LAN)/wide area network (WAN) 120, such as the Internet. Content server 130 is also referred to below as server computer 130 or server 130. In one embodiment, the client device 105 is also in communication with an advertisement server 140. In another embodiment, the server computer 130 is in communication with the advertisement server 140. Although shown as a wireless network 115 and WAN/LAN 120, the client device 105 can communicate with servers 130, 140 via any type of network.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows® Server, Mac® OS X®, Unix®, Linux®, FreeBSD®, or the like.

Content server 130 may include a device that includes a configuration to provide content via a network to another device. A content server 130 may, for example, host a site, such as a social networking site, examples of which may include, without limitation, Flickr®, Twitter®, Facebook®, LinkedIn®, or a personal user site (such as a blog, vlog, online dating site, etc.). A content server 130 may also host a variety of other sites, including, but not limited to business sites, educational sites, dictionary sites, encyclopedia sites, wikis, financial sites, government sites, etc.

Content server 130 may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as a content server include desktop computers, multiprocessor systems, microprocessor-type or programmable consumer electronics, etc.

In one embodiment, the content server 130 hosts or is in communication with a database 160. The database 160 may be stored locally or remotely from the server 130.

A network may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

A wireless network may couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

In one embodiment and as described herein, the client device 105 is a smartphone. In another embodiment, the client device 105 is a tablet. In another embodiment, the client device 105 is a computer, a radio, an Ipod®, etc. The client device 105 is, in one embodiment, in the same room as or near a television 165 (or other media player).

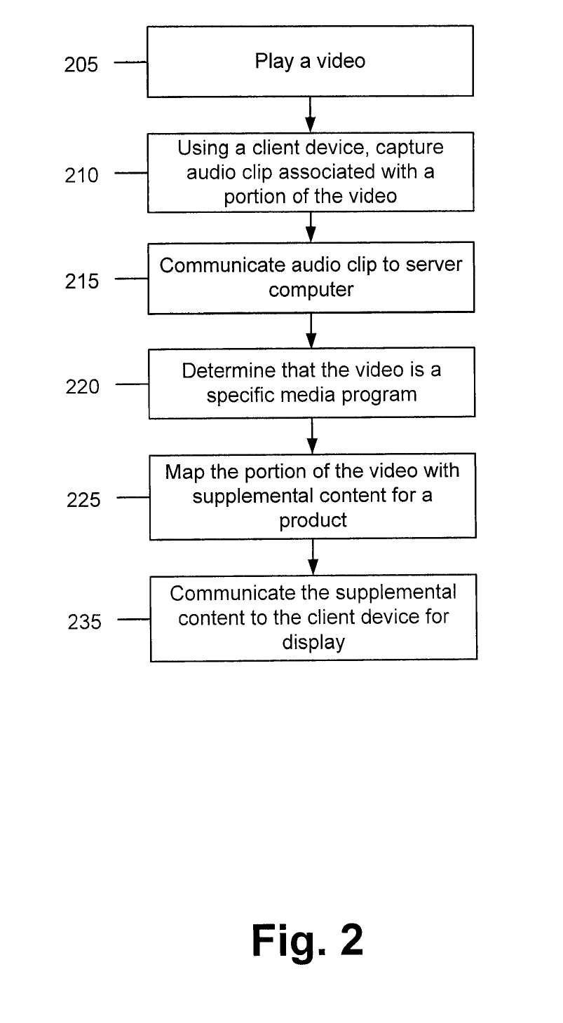

Also referring to FIG. 2, suppose a user of the client device 105 turns on the television 165 and begins experiencing (e.g., watching, listening to) a video played on the television 165 (Step 205). The video may be a television program, a movie, a commercial, internet content, etc. Although described as a video being played on the television, in another embodiment the video is played on a movie screen or the client device 105 or is any other media (e.g., live program, such as a concert) that produces audio. In one embodiment, client device 105 captures or records (e.g., continuously or a portion of, such as the first minute of) the audio 170 (also referred to as audio clip 170) of the video played on the television 165 (Step 210). In one embodiment, the client device 105 records the audio clip 170 via a microphone.

The client device 105 then communicates the captured audio clip 175 to the server computer 130 (Step 215). The server computer 130 determines that the video is a specific media program (Step 220). In one embodiment, the server computer 130 makes this determination via fingerprinting technology. The server computer 130 converts the audio clip 175 into a fingerprint, analyzes the fingerprint associated with the audio clip 175, and matches this fingerprint with reference fingerprints stored in database 160 that are associated with specific media programs (e.g., specific television programs). Fingerprinting technology is described in, for example, U.S. Pat. No. 7,516,074, titled Extraction and Matching of Characteristic Fingerprints from Audio Signals, U.S. Patent Application No. 2009/0157391, titled Extraction and Matching of Characteristic Fingerprints from Audio Signals, and U.S. Patent Application No. 2012/0209612, titled Extraction and Matching of Characteristic Fingerprints from Audio Signals.

In another embodiment, the client device 105 captures the audio clip 170 of a portion of the video and generates one or more fingerprints representing the audio clip 170. Then, instead of transmitting the audio clip 175 to the server computer 130, in one embodiment, the client device 105 transmits fingerprint(s) representing the audio clip 170 to the server 130. In this embodiment, the processing required by the server 130 has decreased because the server 130 does not have to convert the captured audio clip 175 to a fingerprint in order to determine from the audio clip 175 that the video is a specific media program in step 220.

Using the captured audio clip, in one embodiment the server computer 130 maps the portion of the video with supplemental content for a product associated with the portion of the video (Step 225). The supplemental content for a product can include, for example, product information, a coupon, an advertisement, a web page, a link to a web page, and/or a commercial.

In one embodiment, the mapping of a particular product to a portion of a video is stored in database 160. In one embodiment, a third party (e.g., the producer) of the video provides these mappings for one or more of its videos to the server computer 130. For example, suppose Season 5, Episode 10 of the TV program “House” contains a scene in which the character “House” drinks a Diet Coke®. This scene occurs in the program between 10 minutes, 5 seconds and 10 minutes, 35 seconds. In this same program, suppose that a patient of House eats a Hershey's® chocolate bar between 14 minutes, 2 seconds and 14 minutes, 10 seconds. In one embodiment, the producer of “House” (e.g., FOX® Broadcasting Company) provides to the operator of the server computer 130 (e.g., Yahoo!® Inc.) a mapping of the products shown in this program and the associated time periods during which these products are shown. Thus, the mapping of products to this program would include the Diet Coke® soda product with the time frame of 10 minutes, 5 seconds to 10 minutes, 35 seconds and the Hershey's® chocolate bar between 14 minutes, 2 seconds and 14 minutes, 10 seconds of this specific program of “House”.

In another embodiment, one or more people associated with the server computer 130 determine what products are shown at different time periods in a particular media program and produce this mapping manually based on products the person or people see in the program and based on an associated time frame of the media program. In another embodiment, the mapping is automated, such as by using image recognition technology to determine which products are shown in which scenes of a media program to build the map. In one embodiment, the map is built and stored in the database 160 before the airing of the media program and therefore before the client device 105 communicates the captured audio clip 175 to the server computer 130.

The server computer 130 then communicates the supplemental content 180 to the client device 105 for display (Step 235). The client device 105 displays the supplemental content 180 so that the user can view additional information (e.g., product information, an advertisement, etc.) associated with a product that the user just saw on the television 165. The displaying of the supplemental content 180 for a product can result in additional sales of the product, an increase in the number of visits to a particular web page, an increase in the interest of a product, an increase in the amount that the owner of the server computer 130 can charge for advertisements associated with a product, etc.

In one embodiment, the client device 105 has downloaded a mobile application (e.g., via an “app store”) to perform the functions described herein (e.g., recording the audio signal 170 and transmitting the audio clip 175 to the server computer 130). In one embodiment, the mobile application is the IntoNow® mobile application, owned by Yahoo!® Inc. of Sunnyvale, Calif.

The communications between the server computer 130 and the client computer 105 can occur periodically, continuously, randomly, at a set time, once (e.g., at the start of a TV program when a first audio clip is captured), etc.

In one embodiment, the server computer 130 transmits supplemental content 180 for all products associated with a video after receiving the captured audio clip 175 from the client device 105. The user of the client device 105 can then view the supplemental information 180 as the products appear on the television 165. In another embodiment, the server computer 130 transmits supplemental content 180 for products associated with the video within a predetermined buffer. For example, the server computer 130 may receive an audio clip 175 corresponding to the first 20 seconds of a TV program. The server computer 130 can then transmit the supplemental content 180 associated with products for the first minute of the TV program (thus having a buffer of 40 seconds). In one embodiment, the buffer is set by the owner/operator of the server 130. Alternatively, the buffer can be set by the user of the client device 105 and therefore can differ from user to user.

In one embodiment, the client device 105 captures (and transmits) audio clips 170 at different times during a video and subsequently receives supplemental content 180 at these different times. In another embodiment, the client device 105 captures and transmits a single audio clip 175 when the user activates the mobile application on the client device 105 and the server computer 130 transmits supplemental content 180 to the client device throughout the video. For example, the server computer 130 may determine from the audio clip 175 that this particular media program displays four products at different times. The server computer 130 can transmit supplemental content associated with each product at the various times that the different products are displayed (or within a buffer, as described above).

Although described above as playing on a television 165, the video can alternatively or additionally play on the client device 105 itself (e.g., a smartphone, a tablet, a desktop computer, or a laptop computer). In one embodiment, when the user experiences the video, the user can select a displayed product when the user wants to obtain supplemental content associated with the selected product. This selection can be via touch, via voice, or via a cursor. In one embodiment, the selection of a displayed product can be a cursor hovering over the product. Alternatively, the selection of a displayed product can be the clicking of a mouse button when the mouse cursor is on the product.

In one embodiment, the mobile application includes scripting information which enables communication of x and y coordinates of a selection made within the video by a user selection device, such as a mouse, light pen, joystick, keyboard, touch sensitive screen, or other pointing device, that enables moving a pointer or cursor, or otherwise selecting a point or area on a display screen.

If the video is playing on the client device 105, the supplemental content 180 can be displayed adjacent to the video, on top of the video, near the video, or at any other location. If the video is playing on another device (e.g., television 165), the supplemental content 180 can be displayed on the entire screen of the client device 105, on a portion of the screen of the client device 105, as an icon, as a web page or document, etc. In one embodiment, the supplemental content 180 is inserted into the video, such as a commercial for the product inserted between two frames of the video.

In one embodiment, the supplemental content 180 is tagged within the video. For example, data that defines a supplemental content tag (e.g., an advertisement tag) may be embedded into the data that defines the video. A request to retrieve supplemental content 180 associated with a supplemental content tag may be communicated to the advertisement server 140 under various conditions. For example, the request may be generated on a periodic basis, such as every 5 minutes, by a browser through which the video is viewed. The request may also be generated when a user clicks on a particular item, such as an object in the video. An advertisement tag associated with the selection may then be communicated to the advertisement server 140 when the user selects the object. The advertisement server 140 may then communicate the advertisement associated with the advertisement tag to the user.

For example, an advertisement may be inserted between scenes of a video by stopping a video and then displaying an advertisement over the region of a display showing the video or a different region. Advertisements may also be shown as pop up ads floating over a web page or on the top, bottom, sides, or other parts of a web page.

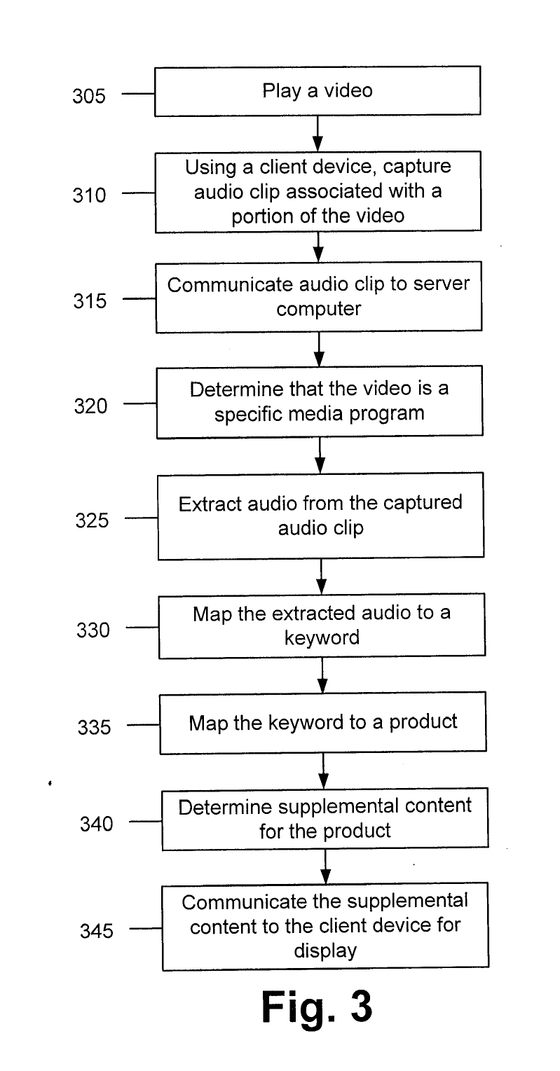

FIG. 3 is a flowchart illustrating an embodiment of steps performed by the client device 105 and server computer 130. As stated above, a video is played (Step 305), the client device 105 captures an audio clip 170 associated with a portion of the video (Step 310), the audio clip 175 is transmitted to the server computer 130 (Step 315), and the server computer 130 determines that the video is a specific media program (Step 320).

In one embodiment, the server computer 130 extracts audio from the captured audio clip 175 (Step 325). The server computer 130 then maps the extracted audio to one or more keywords (Step 330). In one embodiment, the server computer 130 utilizes voice recognition software to perform this mapping. The server computer 130 then maps the keyword to a product. In one embodiment, this mapping is based on a keyword-to-product mapping stored in database 160. In one embodiment and as described above, the keyword-to-product mapping is provided by one or more third parties (e.g., advertisers). In one embodiment, the server computer 130 determines supplemental content for the product (Step 340) and communicates this supplemental content to the client device 105 for display (Step 345).

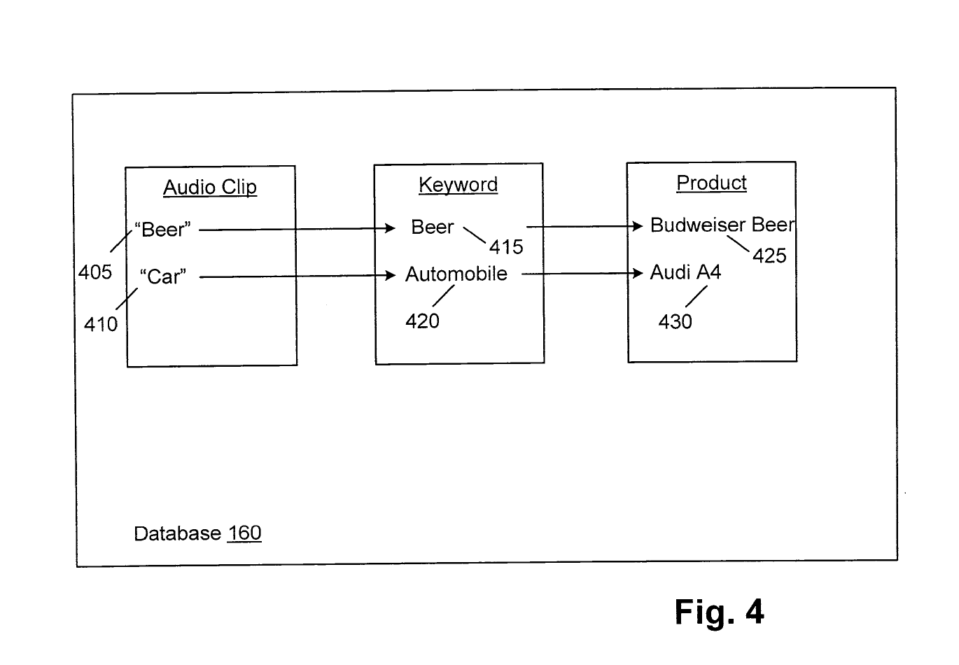

For example and also referring to FIG. 4, suppose the audio clip 170 captured from the television 165 playing a video contains the word “beer” at 1 minute, 35 seconds into the video and the word “car” at 2 minutes, 10 seconds into the video. In one embodiment, the client device 105 transmits the audio clip 175 to the server computer 130 and the server computer 175 determines that this audio clip 175 contains or is associated with the word “beer” 405 at the 1 minute, 35 second time slot and the word “car” 410 at the 2 minutes, 10 seconds time slot (e.g., via voice recognition software or via a map based on the audio clip 175). In one embodiment, the server computer 130 maps the extracted word “beer” 405 to a stored keyword “beer” 415 and the extracted word “car” 410 to a stored keyword “automobile” 420. The server computer 130 then maps the keyword “beer” 415 to a Budweiser® beer 425 and the keyword “automobile” 420 to an Audio® A4 car 430 because the server computer 130 has previously received these keyword-to-product mappings for this video from the producer of this video. Thus, the producer provided the information to the server computer 130 that a Budweiser® beer was referenced (e.g., stated or displayed) at the given time period of the video and that the Audi® A4 was referenced (e.g., stated or displayed) at the given time period of the video. The server computer 130 then determines supplemental content 180 to provide to the client device 105 soon after these parts of the video have been displayed or spoken to the user. For example, the server computer 130 can provide the Budweiser® web page to the client device 105 at or soon after the corresponding segment of the video has played to facilitate the user purchasing Budweiser® beer, finding more information about Budweiser® beer, finding locations near the user that are currently open and/or that sell Budweiser® beer, etc.

In one embodiment, the server computer 130 provides an auction-based system in which advertisers can bid on one or more keywords to be mapped to their product or products. In one embodiment, generic keywords associated with generic products in a video can be bid upon. For example, suppose a bottle of beer is displayed in a certain segment of a video, but the bottle is not labeled or branded in the video. In one embodiment, the keyword “beer” is extracted from the audio associated with this segment of the video. In one embodiment, several beer brands may bid on this keyword, such as Budweiser®, Miller®, and Coors® for supplemental content associated with their brand/beer to be presented during (or soon after) this video segment is displayed. This can be applied to many generic products displayed in a video, such as a wine glass, a drink, a toothpaste tube, etc.

As another example, during a television program, an actor is eating soup. Due to the fact that the specific soup brand was not shown or the manufacturer of the soup had chosen not to advertise on this platform, a keyword in one embodiment is mapped to this segment of the television program to allow soup manufacturers to advertise. Thus, in this example, Campbell's® and Progresso® can now bid for this advertising spot and when a user looks for products during this television program, the winning bidder's advertisement/product link will be displayed.

Various monetization techniques or models may be used in connection with sponsored search advertising, including advertising associated with user search queries, or non-sponsored search advertising, including graphical or display advertising. In an auction-type online advertising marketplace, advertisers may bid in connection with placement of advertisements, although other factors may also be included in determining advertisement selection or ranking. Bids may be associated with amounts advertisers pay for certain specified occurrences, such as for placed or clicked-on advertisements, for example. Advertiser payment for online advertising may be divided between parties including one or more publishers or publisher networks, one or more marketplace facilitators or providers, or potentially among other parties.

Some models include guaranteed delivery advertising, in which advertisers may pay based at least in part on an agreement guaranteeing or providing some measure of assurance that the advertiser will receive a certain agreed upon amount of suitable advertising, or non-guaranteed delivery advertising, which may include individual service opportunities or spot market(s), for example. In various models, advertisers may pay based at least in part on any of various metrics associated with advertisement delivery or performance, or associated with measurement or approximation of particular advertiser goal(s). For example, models may include, among other things, payment based at least in part on cost per impression or number of impressions, cost per click or number of clicks, cost per action or some specified action(s), cost per conversion or purchase, or cost based at least in part on some combination of metrics, which may include online or offline metrics, for example.

A process of buying or selling online advertisements may involve a number of different entities, including advertisers, publishers, agencies, networks, or developers. To simplify this process, organization systems called “ad exchanges” may associate advertisers or publishers, such as via a platform to facilitate buying or selling of online advertisement inventory from multiple ad networks. “Ad networks” refers to aggregation of ad space supply from publishers, such as for provision en masse to advertisers.

For web portals like Yahoo!, advertisements may be displayed on web pages resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users.

As described in more detail below, one approach to presenting targeted advertisements includes employing demographic characteristics (e.g., age, income, sex, occupation, etc.) for predicting user behavior, such as by group. Advertisements may be presented to users in a targeted audience based at least in part upon predicted user behavior(s).

Another approach includes profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users.

Advertisement server 140 comprises a server that stores online advertisements for presentation to users. “Ad serving” refers to methods used to place online advertisements on websites, in applications, or other places where users are more likely to see them, such as during an online session or during computing platform use, for example.

During presentation of advertisements, a presentation system may collect descriptive content about types of advertisements presented to users. A broad range of descriptive content may be gathered, including content specific to an advertising presentation system. Advertising analytics gathered may be transmitted to locations remote to an advertising presentation system for storage or for further evaluation. Where advertising analytics transmittal is not immediately available, gathered advertising analytics may be stored by an advertising presentation system until transmittal of those advertising analytics becomes available.

As stated above, in one embodiment product recognition software is used on one or more frames of a video to identify one or more products in the frame. In one embodiment, the product recognition software recognizes trademarks of known brands. The product recognition software may be part of the mobile application downloaded by the client device 105.

In one embodiment, the server computer 130 stores and/or maintains user information associated with one or more users that downloaded the mobile application. In one embodiment, the server computer 130 tailors the supplemental content provided to the client device 105 based on the user information. For example, suppose two users are watching the same TV program, “Two and a Half Men”. Each user is using his client device 105 and activates (e.g., presses) the mobile application, resulting in an audio clip 175 corresponding to the first minute of the program being sent to the server computer 130. Further suppose that one of the users, user A, is a Chicago Bulls® fanatic while the other user, user B, is a New York Yankees® fan. Suppose that at the fifteen minute mark of the program, one of the actors on the program is discussing buying tickets to go to a sporting event. In one embodiment, the server computer 130 can transmit supplemental content associated with the Chicago Bulls® to user A while transmitting supplemental content associated with the New York Yankees® to user B for the same audio clip 175. The supplemental content can be tailored based on user interests, demographics, location, home address, weather at the particular location or home address, social network “connections” or “friends” of the user (e.g., “friends” on Facebook®, connections on LinkedIn®, followers on Twitter®, etc.), age, income, education, recent purchases, web sites visited recently, gender, marital status, occupation, or any other information associated with the user.

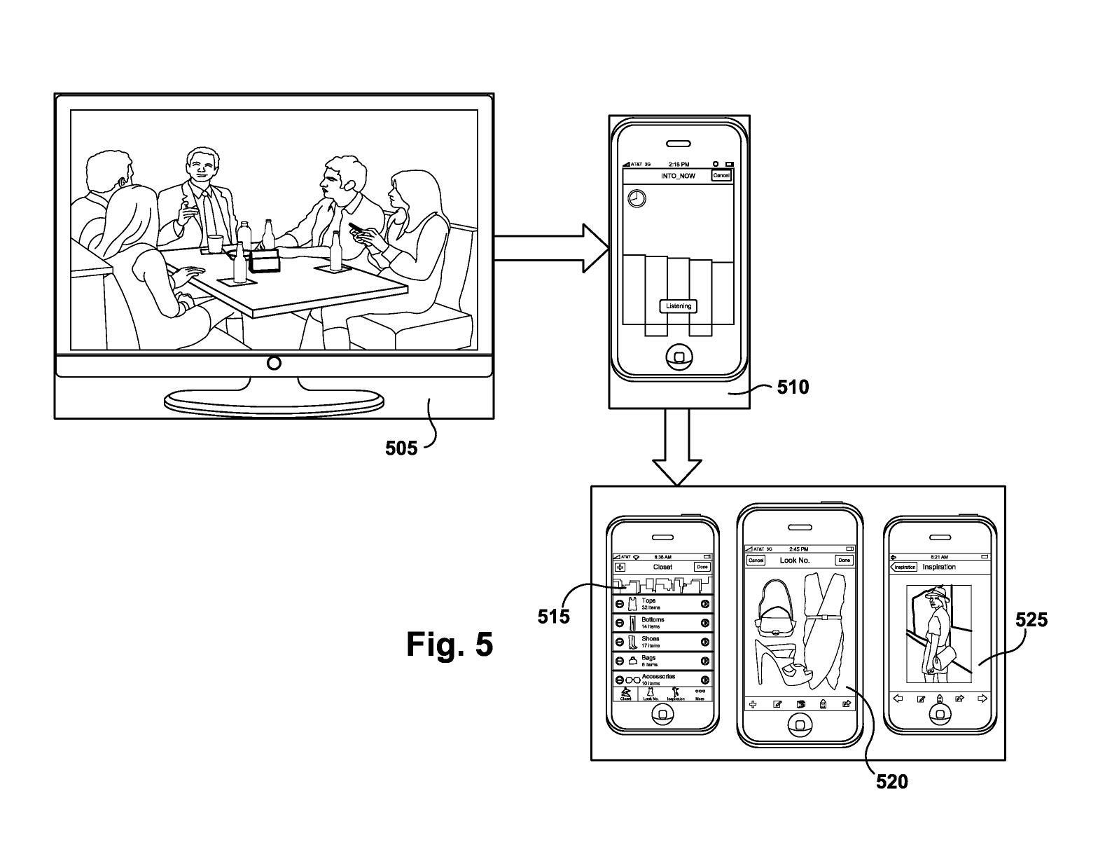

FIG. 5 is a block diagram of an embodiment of a television 505 displaying the TV program “How I Met Your Mother®”. A client device 510 is executing the IntoNow® mobile application, which is capturing an audio clip of the TV program. After the capturing of the audio clip is complete, the client device 510 can display one or more screens. For example, the client device 510 is displaying a screen 515 enabling the user to view different articles of clothing and accessories that are being worn by the actors or actresses on the program. Screen 520 is a more detailed illustration of particular articles of clothing and accessories that the user can purchase. Screen 525 shows an individual wearing the articles of clothing and accessories illustrated in screen 520. Although shown as three screens 515, 520, 525, any number or type of screen can be displayed by the client device 105 in relation to the TV program shown on television 505.

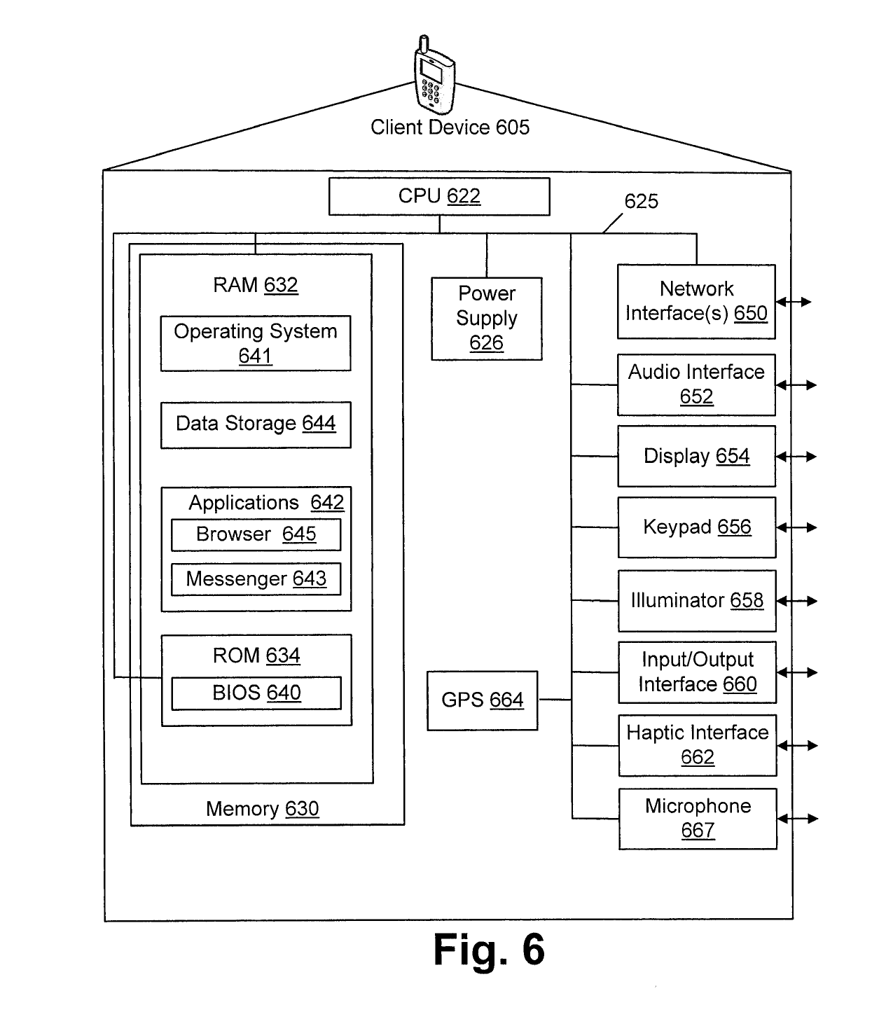

FIG. 6 shows one example of a schematic diagram illustrating a client device 605 (e.g., client device 105). Client device 605 may include a computing device capable of sending or receiving signals, such as via a wired or wireless network. A client device 605 may, for example, include a desktop computer or a portable device, such as a cellular telephone, a smartphone, a display pager, a radio frequency (RF) device, an infrared (IR) device, a Personal Digital Assistant (PDA), a handheld computer, a tablet computer, a laptop computer, a digital camera, a set top box, a wearable computer, an integrated device combining various features, such as features of the foregoing devices, or the like.

The client device 605 may vary in terms of capabilities or features. Claimed subject matter is intended to cover a wide range of potential variations. For example, a cell phone may include a numeric keypad or a display of limited functionality, such as a monochrome liquid crystal display (LCD) for displaying text, pictures, etc. In contrast, however, as another example, a web-enabled client device may include one or more physical or virtual keyboards, mass storage, one or more accelerometers, one or more gyroscopes, global positioning system (GPS) or other location-identifying type capability, of a display with a high degree of functionality, such as a touch-sensitive color 2D or 3D display, for example.

A client device 605 may include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating one or more messages, such as via email, short message service (SMS), or multimedia message service (MMS), including via a network, such as a social network, including, for example, Facebook®, LinkedIn®, Twitter®, Flickr®, or Google+®, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally stored or streamed video, or games (such as fantasy sports leagues). The foregoing is provided to illustrate that claimed subject matter is intended to include a wide range of possible features or capabilities.

As shown in the example of FIG. 6, client device 605 may include one or more processing units (also referred to herein as CPUs) 622, which interface with at least one computer bus 625. A memory 630 can be persistent storage and interfaces with the computer bus 625. The memory 630 includes RAM 632 and ROM 634. ROM 634 includes a BIOS 640. Memory 630 interfaces with computer bus 625 so as to provide information stored in memory 630 to CPU 622 during execution of software programs such as an operating system 641, application programs 642, device drivers, and software modules 643, 645 that comprise program code, and/or computer-executable process steps, incorporating functionality described herein, e.g., one or more of process flows described herein. CPU 622 first loads computer-executable process steps from storage, e.g., memory 632, data storage medium/media 644, removable media drive, and/or other storage device. CPU 622 can then execute the stored process steps in order to execute the loaded computer-executable process steps. Stored data, e.g., data stored by a storage device, can be accessed by CPU 622 during the execution of computer-executable process steps.

Persistent storage medium/media 644 is a computer readable storage medium(s) that can be used to store software and data, e.g., an operating system and one or more application programs. Persistent storage medium/media 644 can also be used to store device drivers, such as one or more of a digital camera driver, monitor driver, printer driver, scanner driver, or other device drivers, web pages, content files, playlists and other files. Persistent storage medium/media 606 can further include program modules and data files used to implement one or more embodiments of the present disclosure.

For the purposes of this disclosure a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

Client device 605 can also include one or more of a power supply 626, network interface 650, audio interface 652, a display 654 (e.g., a monitor or screen), keypad 656, illuminator 658, I/O interface 660, a haptic interface 662, a GPS 664, a microphone 667, a video camera, TV/radio tuner, audio/video capture card, sound card, analog audio input with A/D converter, modem, digital media input (HDMI, optical link), digital I/O ports (RS232, USB, FireWire, Thunderbolt), expansion slots (PCMCIA, ExpressCard, PCI, PCIe).

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may be grouped into an engine or an application.

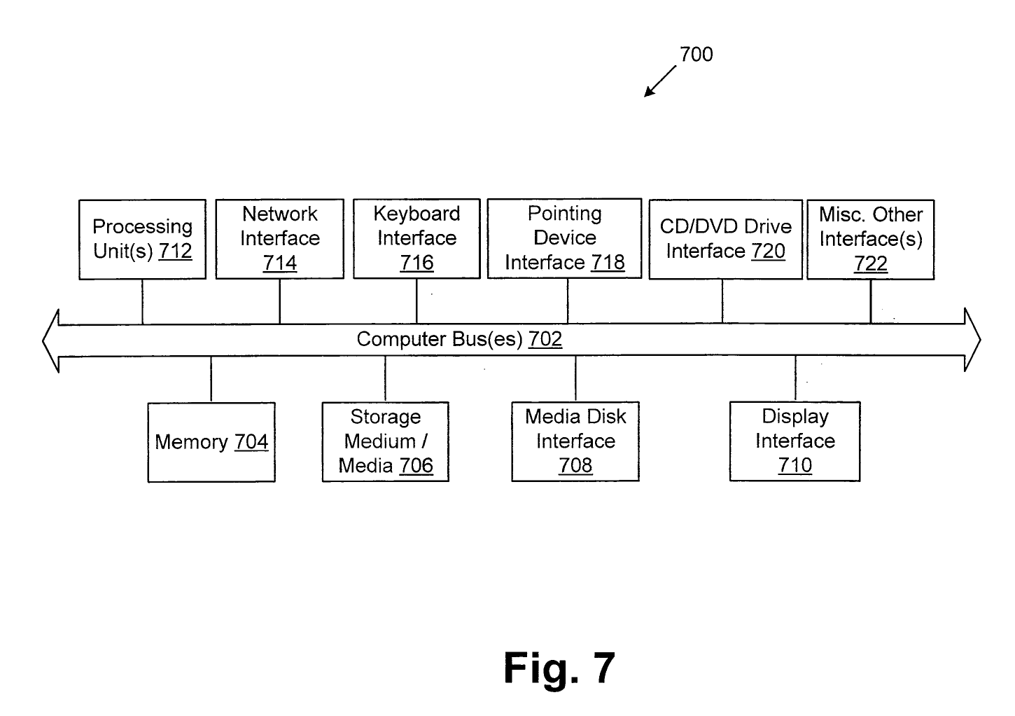

FIG. 7 is a block diagram illustrating an internal architecture of an example of a computer, such as server computer 130, 140 and/or client device 105 in accordance with one or more embodiments of the present disclosure. A computer as referred to herein refers to any device with a processor capable of executing logic or coded instructions, and could be a server, personal computer, set top box, tablet, smart phone, pad computer or media device, to name a few such devices. As shown in the example of FIG. 7, internal architecture 700 includes one or more processing units (also referred to herein as CPUs) 712, which interface with at least one computer bus 702. Also interfacing with computer bus 702 are persistent storage medium/media 706, network interface 714, memory 704, e.g., random access memory (RAM), run-time transient memory, read only memory (ROM), etc., media disk drive interface 708 as an interface for a drive that can read and/or write to media including removable media such as floppy, CD-ROM, DVD, etc. media, display interface 710 as interface for a monitor or other display device, keyboard interface 716 as interface for a keyboard, pointing device interface 718 as an interface for a mouse or other pointing device, and miscellaneous other interfaces not shown individually, such as parallel and serial port interfaces, a universal serial bus (USB) interface, and the like.

Memory 704 interfaces with computer bus 702 so as to provide information stored in memory 704 to CPU 712 during execution of software programs such as an operating system, application programs, device drivers, and software modules that comprise program code, and/or computer-executable process steps, incorporating functionality described herein, e.g., one or more of process flows described herein. CPU 712 first loads computer-executable process steps from storage, e.g., memory 704, storage medium/media 706, removable media drive, and/or other storage device. CPU 712 can then execute the stored process steps in order to execute the loaded computer-executable process steps. Stored data, e.g., data stored by a storage device, can be accessed by CPU 712 during the execution of computer-executable process steps.

As described above, persistent storage medium/media 706 is a computer readable storage medium(s) that can be used to store software and data, e.g., an operating system and one or more application programs. Persistent storage medium/media 706 can also be used to store device drivers, such as one or more of a digital camera driver, monitor driver, printer driver, scanner driver, or other device drivers, web pages, content files, playlists and other files. Persistent storage medium/media 706 can further include program modules and data files used to implement one or more embodiments of the present disclosure.

Internal architecture 700 of the computer can include (as stated above), a microphone, video camera, TV/radio tuner, audio/video capture card, sound card, analog audio input with A/D converter, modem, digital media input (HDMI, optical link), digital I/O ports (RS232, USB, FireWire, Thunderbolt), and/or expansion slots (PCMCIA, ExpressCard, PCI, PCIe).

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the user computing device or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While the system and method have been described in terms of one or more embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1. A method comprising:
receiving, by a server computer over a network from a client device, an audio clip associated with a portion of a video;
determining, by the server computer, that the video is a specific media program;
using, by the server computer, the captured audio clip to map the portion of the video with supplemental content for a product associated with the portion of the video; and
communicating, by the server computer, the supplemental content for the product to the client device for display on the client device.

2. The method of claim 1, further comprising determining, by the server computer, that the product is referenced in the portion of the video.

3. The method of claim 2, further comprising determining that the audio clip references the product.

4. The method of claim 2, further comprising determining that a frame in the portion of the video comprises the product.

5. The method of claim 1, further comprising receiving, by the server computer, a listing of supplemental content for the specific media program.

6. The method of claim 5, wherein the receiving of the listing of supplemental content further comprises receiving supplemental content for specific time segments of the specific media program.

7. The method of claim 1, wherein the video is a media program from a group of media programs consisting of a television program, a movie, a commercial, and internet content.

8. The method of claim 1, wherein the supplemental content for the product is supplemental content from a group of supplemental content consisting of product information, a coupon, an advertisement, a web page, a link to a web page, and a commercial.

9. The method of claim 1, further comprising tailoring, by the server computer, the supplemental content for a user based on user information.

10. The method of claim 9, wherein the tailored supplemental content is tailored based on user information from a group of user information consisting of user interests, demographics, location, home address, weather at the location, weather at the home address, social network connections of the user, social network friends of the user, age, income, education, recent purchases, web sites visited recently, gender, marital status, and occupation.

11. A server computer comprising:
a processor;
a storage medium for tangibly storing thereon program logic for execution by the processor, the program logic comprising:
receiving logic executed by the processor for receiving, over a network from a client device, an audio clip associated with a portion of a video;
determining logic executed by the processor for determining that the video is a specific media program;
mapping logic executed by the processor for mapping, using the captured audio clip, the portion of the video with supplemental content for a product associated with the portion of the video; and
communicating logic executed by the processor for communicating the supplemental content for the product to the client device for display on the client device.

12. The server computer of claim 11, wherein the determining logic further comprises logic for determining that the product is referenced in the portion of the video.

13. The server computer of claim 11, wherein the receiving logic further comprises logic for receiving a listing of supplemental content for the specific media program.

14. The server computer of claim 13, wherein the logic for receiving a listing of supplemental content further comprises logic for receiving supplemental content for specific time segments of the specific media program.

15. The server computer of claim 11, wherein the supplemental content for the product is supplemental content from a group of supplemental content consisting of product information, a coupon, an advertisement, a web page, a link to a web page, and a commercial.

16. The server computer of claim 11, wherein the mapping logic further comprises tailoring logic for tailoring the supplemental content for a user based on user information.

17. The server computer of claim 16, wherein the tailored supplemental content is tailored based on user information from a group of user information consisting of user interests, demographics, location, home address, weather at the location, weather at the home address, social network connections of the user, social network friends of the user, age, income, education, recent purchases, web sites visited recently, gender, marital status, and occupation.

18. A method comprising:
transmitting, by a server computer over a network to a client device, a mobile application, the mobile application comprising supplemental content associated with a plurality of media programs, the mobile application configured to:
capture, by the client device, an audio clip associated with a portion of a video;
determine, by the client device from the audio clip, that the video is a specific media program in the plurality of media programs;
determine, by the client device, supplemental content for a product associated with the portion of the video; and
display, by the client device, the supplemental content.

19. The method of claim 18, wherein the mobile application is further configured to receive, by the client device, the supplemental content associated with the plurality of media programs.

20. The method of claim 18, wherein the mobile application is further configured to determine, by the client device, that the product is referenced in the portion of the video.

21. The method of claim 18, wherein the mobile application is further configured to receive, by the client device, a listing of supplemental content, each supplemental content in the listing for specific time segments of the specific media program.

22. The method of claim 18, wherein the supplemental content for the product is supplemental content from a group of supplemental content consisting of product information, a coupon, an advertisement, a web page, a link to a web page, and a commercial.

23. The method of claim 18, wherein the mobile application is further configured to tailor, by the client device, the supplemental content for a user based on user information.

24. A method comprising:
receiving, by a server computer over a network from a client device, an audio clip associated with a portion of a video;
determining, by the server computer, that the video is a specific media program;
extracting, by the server computer, audio from the captured audio clip;
mapping, by the server computer, the extracted audio to a keyword;
mapping, by the server computer, the keyword to a product;
determining, by the server computer, supplemental content for the product; and
communicating, by the server computer, the supplemental content for the product to the client device for display on the client device.

25. The method of claim 24, further comprising receiving, by the server computer, mappings from keywords to products.

26. The method of claim 24, further comprising receiving, by the server computer, a listing of supplemental content for the specific media program.

27. The method of claim 24, wherein the video is a media program from a group of media programs consisting of a television program, a movie, a commercial, and internet content.

28. The method of claim 24, wherein the supplemental content for the product is supplemental content from a group of supplemental content consisting of product information, a coupon, an advertisement, a web page, a link to a web page, and a commercial.

29. The method of claim 24, further comprising tailoring, by the server computer, the supplemental content for a user based on user information.

30. A server computer comprising:
a processor;
a storage medium for tangibly storing thereon program logic for execution by the processor, the program logic comprising:
receiving logic executed by the processor for receiving, over a network from a client device, an audio clip associated with a portion of a video;
determining logic executed by the processor for determining that the video is a specific media program;
extracting logic executed by the processor for extracting audio from the captured audio clip;
mapping logic executed by the processor for mapping the extracted audio to a keyword and for mapping the keyword to a product;
determining logic executed by the processor for determining supplemental content for the product; and
communicating logic executed by the processor for communicating the supplemental content for the product to the client device for display on the client device.

31. A non-transitory computer readable storage medium tangibly storing computer program instructions capable of being executed by a computer processor, the computer program instructions defining the steps of:
receiving, by the computer processor over a network from a client device, an audio clip associated with a portion of a video;
determining, by the computer processor, that the video is a specific media program;
using, by the computer processor, the captured audio clip to map the portion of the video with supplemental content for a product associated with the portion of the video; and
communicating, by the computer processor, the supplemental content for the product to the client device for display on the client device.

32. A non-transitory computer readable storage medium tangibly storing computer program instructions capable of being executed by a computer processor, the computer program instructions defining the steps of:
receiving, by the computer processor over a network from a client device, an audio clip associated with a portion of a video;
determining, by the computer processor, that the video is a specific media program;
extracting, by the computer processor, audio from the captured audio clip;
mapping, by the computer processor, the extracted audio to a keyword;
mapping, by the computer processor, the keyword to a product;
determining, by the computer processor, supplemental content for the product; and
communicating, by the computer processor, the supplemental content for the product to the client device for display on the client device.
